(19) United States
(12) Patent Application Publication
(10) Pub. No.: US 2013/0027226 A1
(43) Pub. Date: Jan. 31, 2013

(54) MOVING MAP DISPLAY

(71) Applicant: Ralf Cabos, Singapore (SG)

(72) Inventor: Ralf Cabos, Singapore (SG)

(73) Assignee: FLIGHT FOCUS PTE. LTD., (SG)

(21) Appl. No.: 13/640,704

(22) PCT Filed: Apr. 12, 2011
(86) PCT No.: PCT/IB2011/051558

§ 371 Date: Oct. 11, 2012

(30) Foreign Application Priority Data
Apr. 12, 2010 (IB) PCT/IB2010/051563

(51) Int. Cl. G01C 21/00; G08G 5/04

(52) U.S. Cl. 340/961; 340/971

(57) ABSTRACT

A Device for automatically evaluating an air traffic control message by an aircraft-based component of a flight information system is disclosed. The device comprises means for retrieving the air traffic control message from an aircraft-based system, means for parsing the text of the air traffic control message and means for storing text elements of the air traffic control message into a computer readable memory. Furthermore, it comprises means for retrieving a current flight data of an aircraft, means for determining if there is a mismatch between the stored text elements and the current flight data, the actual flight data comprising at least the current position of the aircraft and means for displaying one or more graphical elements on a moving map display if it is determined that there is a mismatch between the stored text elements and the current flight data.

The imperative for increasing levels of safety in the aviation industry has created an environment within which new and novel tools are being developed to assist navigation, reduce, and make pilot workload more efficient, and to enhance safety. Among the tools being developed are electronic flight bags. Electronic flight bags are in operation today offering a variety of functions and features aimed at providing users with an enhanced toolkit for flight operations. From a safety viewpoint, the inclusion of a moving map display provides additional safety enhancements to the flight crew. Current generation electronic flight bags are mainly used as a repository and electronic access device for many of the paper-based products traditionally carried in hard copy.

In contrast, according to the present application an advanced system is provided which displays, in an intuitive way, electronic flight documents, dynamic updates to weather and NOTAM carried onboard as part of the flight crew briefing package, which furthermore incorporates information from other onboard warning systems such as the onboard flight planning system, which provides a system for visual taxiway guidance to assist in the avoidance of runway incursions while the aircraft is on the manoeuvring area of an airport, and which provides a monitoring and alerting mechanism associated with adherence to air traffic clearances and air traffic instructions.

Furthermore, the advanced system according to the application incorporates communications facilities with global coverage, providing the flight crew with the capability to display text messages on the display in conjunction with a moving map, which shows the position of the aircraft. An alert of a closed runway at the destination report which was received via NOTAM (Notice to Airmen) may be shown on the display using easily identifiable symbols. Similarly, updates or indications of hazardous weather are shown on the display, geo-referenced to the main display and to the route of the flight.

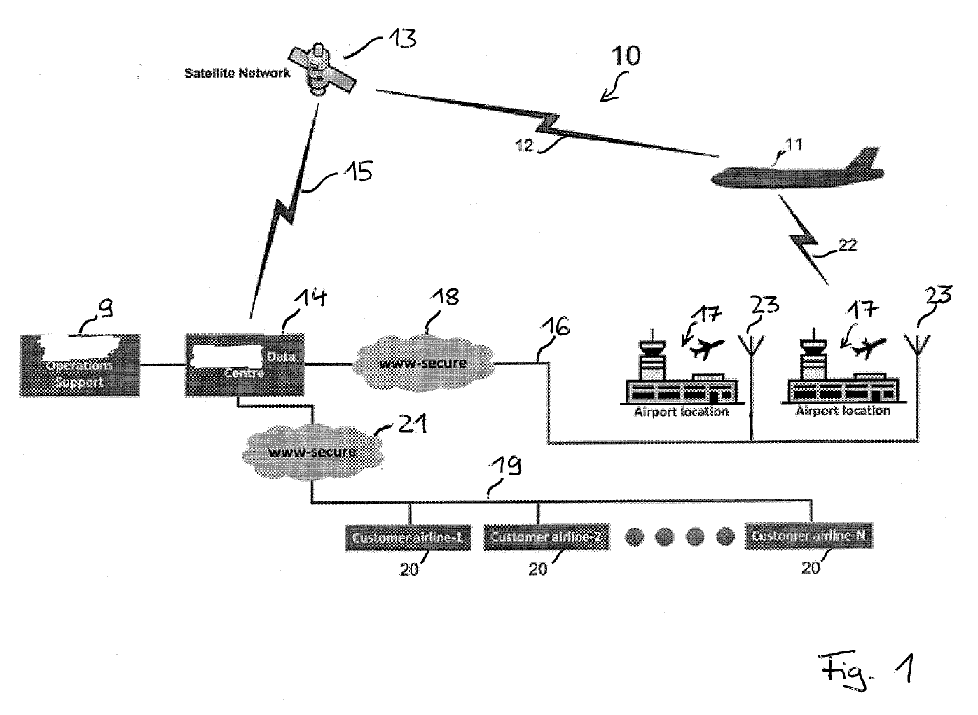

FIG. 1 illustrates a flight information system,

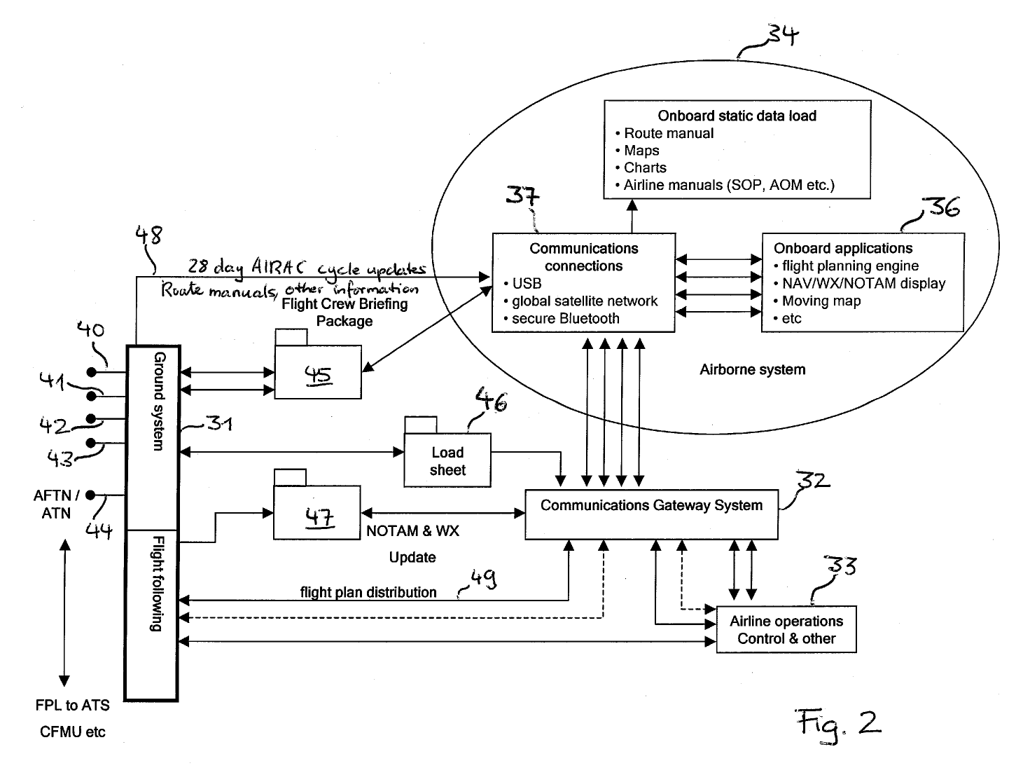

FIG. 2 illustrates a data exchange diagram of the flight information system of FIG. 1,

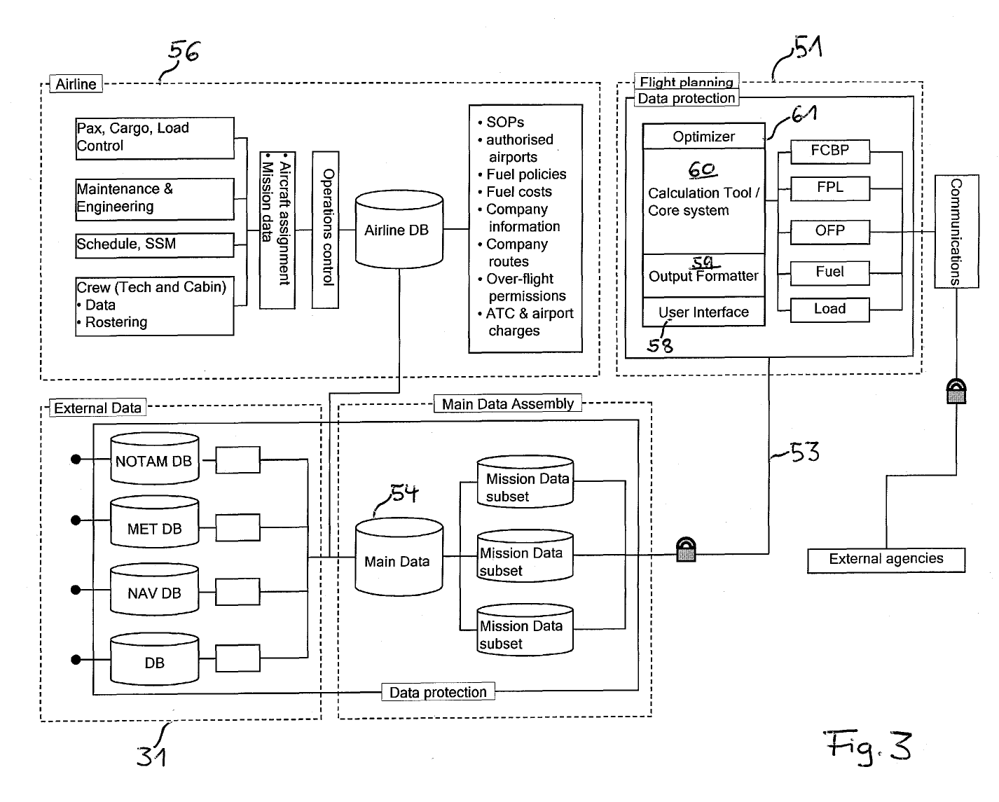

FIG. 3 illustrates a data exchange diagram of a flight planning system,

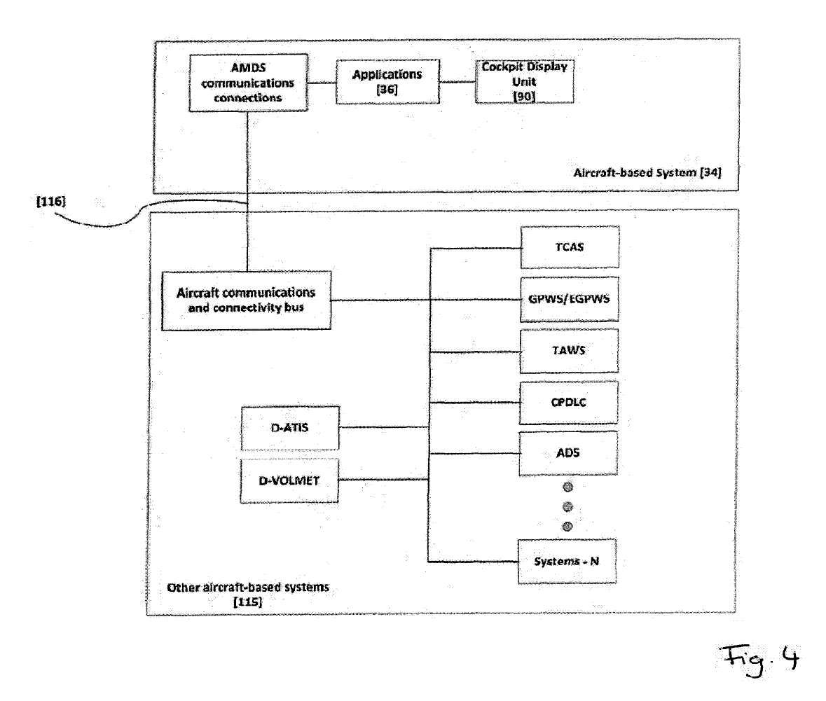

FIG. 4 shows a data flow diagram comprising a cockpit display unit, an aircraft communications bus and various data sources,

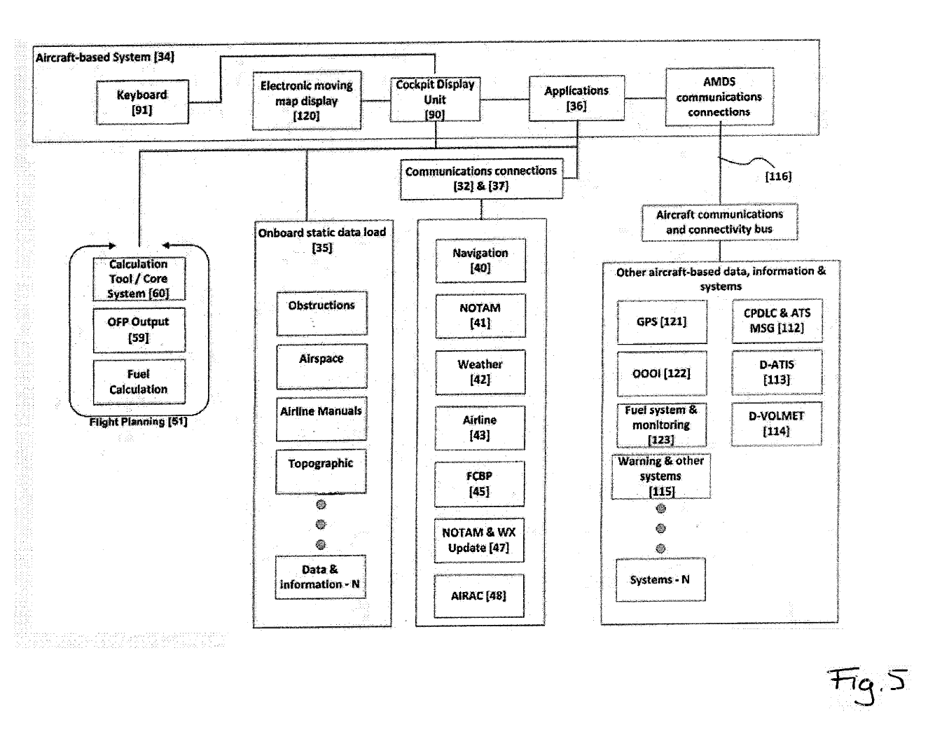

FIG. 5 shows a first data flow diagram for generating an electronic moving map display,

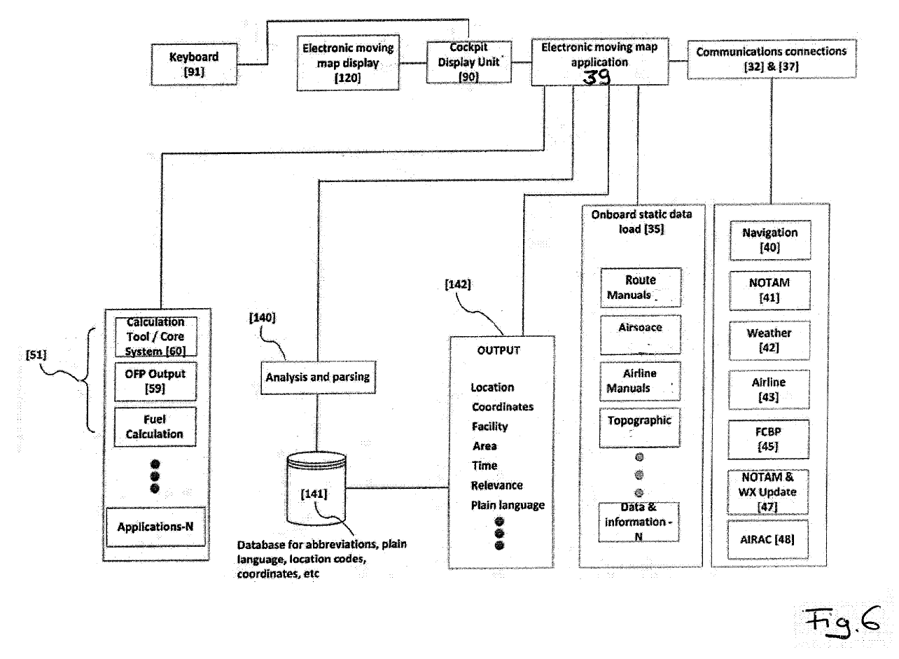

FIG. 6 shows a second data flow diagram for generating an electronic moving map display,

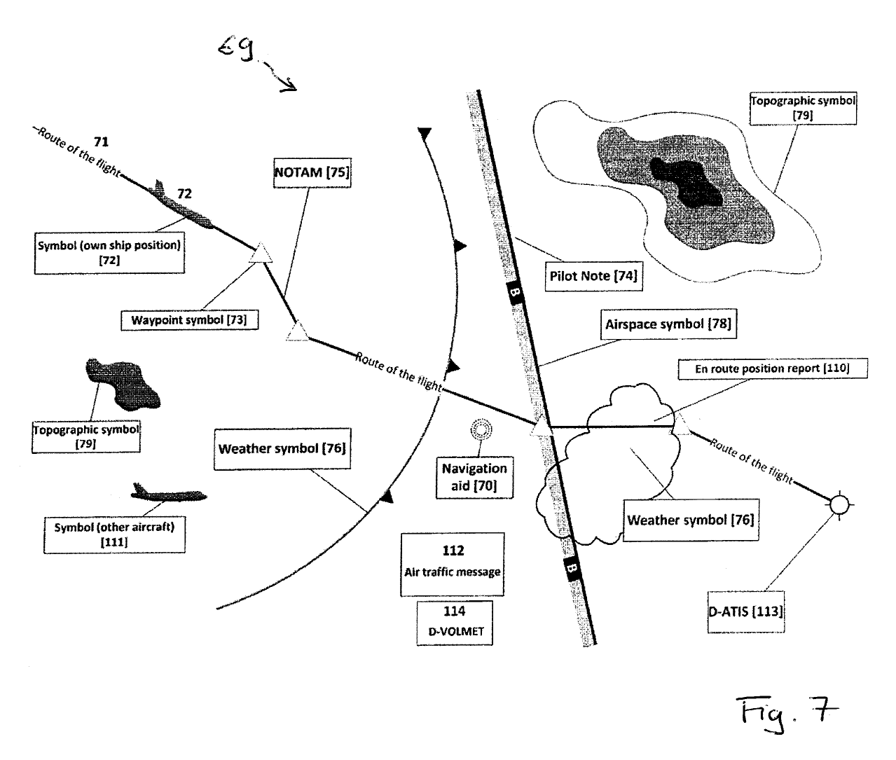

FIG. 7 illustrates a screenshot of the electronic moving map display, and

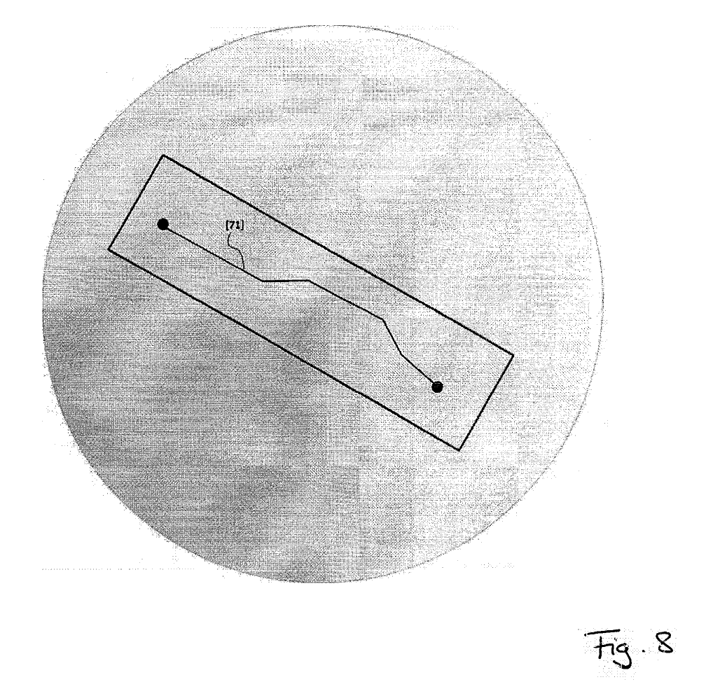

FIG. 8 illustrates a graphical representation of a flight route on the electronic map display.

In the following description, details are provided to describe the embodiments of the application. It shall be apparent to one skilled in the art, however, that the embodiments may be practised without such details.

FIG. 1 shows an operational diagram of a flight information system 10 which will also be referred to as advanced mission display system (AMDS).

Aircraft-based components of the flight information system 10 are provided on a aircraft 11. The aircraft-based components include, among others, one or more displays, a computer, means for communication and data exchange and on board applications and data which are stored on a computer readable medium.

A first satellite communication link 12 connects the aircraft-based components of the flight information system 10 to a satellite 13. The satellite 13 forms part of a network of satellites which are arranged to provide a global coverage of satellite communication links, such as the Iridium network. A second satellite communication link 15 is provided between a data center 14 and the satellite 13. The connection between the data center 14 and the satellite may involve intermediate nodes, for example of an aeronautical telecommunication network, which are not shown in FIG. 1.

The data center 14 is connected to an operations support center 9. Airport communication links 16 are provided between the data center 14 and airports 17. The airport communication links 16 comprise a first secure internet connection 18. Airline communication links 19 are provided between the data center 14 and airline offices 20. The airline communication links 19 comprise a second secure internet connection 21.

Furthermore, a Bluetooth data link 22 is provided between an antenna 23 at an airport 17 and the aircraft 11. The Bluetooth data link 22 serves to connect the aircraft 11 to the data center 14 via the airport communication link 16 while the aircraft 11 is on ground.

FIG. 2 shows a data exchange diagram between ground-based and aircraft-based components of the flight information system 10. The ground-based components comprise an operations center 31, a communications gateway system 32 and airline information providers 33. An aircraft-based component 34 is located on an aircraft, which is not shown in FIG. 2. It comprises a storage 35 for static data, onboard applications 36 and communication means 37. The communication means 37 include various communication devices for establishing connections such as a USB connection, a connection via a global satellite network or a secure Bluetooth connection. Furthermore, the aircraft-based component 34 comprises a connection to an internal databus of the aircraft for determine the status of the aircraft, for example to determine whether the engines of the aircraft are running or if they are stopped. The aircraft-based component 34 also comprises a graphical display and an input means for accepting user input such as a keyboard or a touch screen.

The operations center 31 has interfaces 40, 41, 42, 43 for obtaining flight navigation data, Notices to Airmen (NOTAM), weather data and airline data, respectively. A further interface 44 is provided for exchanging information via an aeronautical fixed telecommunications network (AFTN) or via an aeronautical telecommunications network (ATN). The information comprises, for example, flight plans and other air traffic services messages to air traffic services, such as change or delay messages as, for example, FPL, CHG, DLA etc to ATS, as well as data to and from a central flow management unit (CFMU), etc.

Various communication channels are provided for interchanging data between the operations center 31 and the aircraft-based component 34. The various types of data which are exchanged via the communication channels between the operations center 31 and the aircraft-based component 34 include, among others, flight crew briefing packages 45, load sheets 46, NOTAM and weather (WX) updates 47. Specifically, an update channel 48 is provided for exchanging AIRAC (aeronautical information regulation and control) updates, Route Manuals and further data. A distribution channel 49 is provided for distributing flight planning data and any changes to that data to the ground system 31 after a flight plan has been produced onboard the aircraft.

The data center 14 receives flight navigation data and information (Navdata) over the interface 40 from various sources including data and information for navigational and other purposes. A flight planning application onboard the aircraft 11 uses the flight navigation data and information to compute a flight plan for the aircraft 11.

The data center 14 receives the navigation and information from State and/or other authorized sources, such as Route Manuals. The navigation data and information comprises details relating to facilities, services, rules, regulations and procedures, locations, airspace, routes, waypoints and turning points, radio navigation aids or systems, aerodromes, terrain data and obstacles.

FIG. 3 shows a data exchange diagram of a flight planning system 50, which is part of the flight information system 10 on board the aircraft 11. The flight planning system 50 comprises a flight planning unit 51 which is realized as one of the onboard applications 36 the aircraft-based component 34 of FIG. 2. The flight planning unit 51 is connected to a main data assembly 52 via a secure channel 33. A main database 54 of the main data assembly 52 is connected to an external data source 35 and an airline data source 56.

The flight planning unit 51 comprises a user interface 58, a data output interface 59, a flight planning engine 60 and a flight route optimizer 61. Output from the flight planning unit 51 comprises, amongst others, a flight crew briefing package which also contains an operational flight plan, NOTAM and weather information relating to the flight, the air traffic services notification of the flight, which is known as a FPL, the operational flight plan for use by the flight crew and for distribution to the airline and to the operations centre 31, a fuel calculation and data for a fuel order, a load sheet and loading instructions.

The flight planning unit 51 obtains input data via the secure channel 53. The input data which is provided by the ground-based components to the aircraft-based component 34 may include data published by the airline's commercial scheduling department, engineering and maintenance, crew management, loading data relating to the expected number of passengers, and expected freight and cargo load, navigational data, including over flight permissions, aircraft specific data, including the Minimum Equipment List (MEL) status of the aircraft, and NOTAM and weather data and information. The flight planning unit 51 uses the flight planning engine 60 to generate flight related output data from the input data. The flight related output data comprise an operational flight plan (OFP), a flight plan (FPL), a flight crew briefing package, data for a fuel order, and information for an onboard load sheet application. After generation of the flight related output data, the flight planning unit 51 publishes and distributes the flight related output data to various aircraft-based and ground-based applications and devices.

The flight planning unit 51 comprises various modules for performing the various calculation tasks that are required for generating a flight plan. Namely, the flight planning unit 51 comprises a flight route calculation and generation module, a flight route optimization module, a fuel calculation module and a cost calculation module.

Furthermore, the flight planning unit 51 comprises a crew briefing generation module and a message generation module for generating messages in standardized output formats such as OFP and FPL formats. The data in the standardized output format may then be displayed on board and it may be transmitted to the ground based system or to air traffic services and other agencies where it can be read and processed.

FIG. 4 shows a data flow diagram comprising a cockpit display unit 90, an aircraft communications bus 116 and various data sources.

An aircraft based system 34 is connected to other aircraft based systems 115 via an aircraft communications and connectivity bus 116. The aircraft based system comprises a cockpit display unit 90 which includes in it a computer operating system, computer processor units, computer memory and computer applications, is connected to other aircraft based systems. The computer comprises a memory in which computer readable code for various onboard applications, including a moving map application 39, are stored. The computer is connected to the aircraft communications and connectivity bus via communications connections of the flight information system 10.

The aircraft communications and connectivity bus 116 connects the aircraft based system 34 to other aircraft based systems 115, such as, among others, a traffic alert/collision avoidance system (TCAS), a ground proximity warning system (GPWS/EGPWS), a terrain awareness and warning system (TAWS), a controller pilot data link communications system (CPDLC), an automatic dependent surveillance system (ADS), a system for receiving data from a digital automatic terminal information service (D-ATIS) and a system for receiving digital meteorological information for aircraft in flight (D-VOLMET).

FIGS. 5 and 6 show data connections between a cockpit display unit 90 and various data sources for retrieving information to be displayed on the cockpit display unit 90. The aircraft based system 34 is connected to a flight planning system 51 for retrieving an operational flight plan (OFP) which provides the route of the flight, and calculated data such as the amount of required fuel. The aircraft based system 34 is connected to a memory which comprises onboard static data load 35 such as an obstructions database, an airspace information database, airline manuals, topographic information database and so on. The aircraft based system 34 is furthermore connected to output interfaces of the flight planning system 51, the onboard static data load 35 and, via communications connections 32 and 37, to external data sources 40, 41, 42, 43, 45, 47, 48. The external data sources comprise, among others, sources of navigation messages 40, NOTAM messages 41, weather messages 42, airline specific messages 43, flight crew briefing package information 45, NOTAM and weather updates 47, AIRAC (Aeronautical Information Regulation and Control) cycle updates 48. Moreover, the aircraft based system 34 is also connected to the aircraft communications and connectivity bus 116 via communication electronics of the AMDS. The aircraft communications and connectivity bus connects 116 the aircraft based system 34 to other aircraft based databases and systems. Among others, the databases and systems comprise a CPDLC and ATS message data source 112, a D-ATIS message data source 113, a D-VOLMET message data source 114, GPS system 121, an OOOI (out, off, on, in) events data source 122, a fuel system and monitoring data source 123, a warning system and other systems 115.

During a flight of the aircraft, the ground-based component of the flight information system 10 receives flight navigation data and information, NOTAMs, weather information and airline data from various external sources and stores the information in a ground-based database. The aircraft-based component 34 retrieves via a synchronised data flow the information of the ground-based database from the ground-based component. The data and information for a particular flight is mission specific, that is, that data that is synchronised between the ground-based system and the aircraft-based component 34 is for that aircraft 11 and for that flight or series of flights by that aircraft 11.

Furthermore, the ground-based component sends information to the aircraft 11 without a prior request from the aircraft. Data and information in the ground-based system and the aircraft-based component 34 are synchronised so that the ground-system and the ground-based database is aware of the data that has been provided to the aircraft-based component 34 and filters new or changed data and information entering the ground-based system from the various external data sources.

The moving map application 39 retrieves information to be displayed from the external sources and from aircraft-based databases and systems. An electronic moving map display 69 displays information in either a user selectable 2-D or 3-D view.

Specifically, the moving map application 39 retrieves flight navigation data and information 40, such as information relating to topography, hydrography, cultural features, aerodromes, radio navigation aids and obstacles, air traffic services information, routes and waypoints, airspace boundary divisions and airspace classifications. Furthermore, the moving map application 39 also retrieves information from flight crew briefing package data 45 and from NOTAM updates 41 and weather updates 42 which are sent to the aircraft. In particular, the meteorological data comprise text, graphics and data.

The moving map display 69 is closely linked to other aircraft systems that receive and process messages coming from datalink sources such as CPDLC (Controller Pilot Data Link Communications) and PDC (Pre Departure Clearance). The moving map application 39 on the aircraft system, in addition to displaying the text of the CPDLC and PDC messages, enhances safety by correlating the text of the message with the operation of the aircraft in terms of adherence to the air traffic clearance or air traffic instruction to operate in accordance with certain specified conditions, such as to operate at a specific height, or along a certain airway or route. For example, a PDC message contains a certain amount of text depending on the text length of the route field and whether or not air traffic control inserts any additional remarks to clarify the message being sent via PDC. The text of the PDC contains information describing the time the message was originated, the callsign identification of the aircraft, the aircraft type, the departure aerodrome and time, the destination aerodrome and the route of the flight, the standard instrument departure (SID), the route that the aircraft is to follow between the departure point and the destination, the initial altitude or flight level that the aircraft is to operate at, a radio frequency on which to communicate with air traffic control, a secondary surveillance transponder code assigned to the flight, and any other remarks necessary to clarify the message.

The aircraft-based moving map application 39, after receipt of the PDC message from other aircraft-based systems of the aircraft 11, analyses the PDC message and takes specific parts of the message as part of the route and level monitoring and alerting function. For example, the aircraft-based component 34 firstly confirms that the message has been received for the correct flight by correlating the flight number with that from the OFP, and for the route that the aircraft has been flight planned to operate on by correlating this information with the information that has been supplied to it by the flight planning system OFP in terms of the airways and waypoints. If these details are not able to be correctly correlated between the PDC message and what is held by the moving map application 39, an alert is provided to the flight crew on cockpit display unit 90, such as “FLIGHT NUMBER AND ROUTE DO NOT CORRESPOND, PLEASE CONFIRM PDC WITH ATC”. The initial altitude or flight level provided in the PDC are displayed to the flight crew in the form of text on the moving map display 69.

Should the flight crew not adhere to the terms and conditions of the air traffic clearance of the air traffic instruction, as prescribed by the PDC or other update, the moving map display 69 provides a warning to the flight crew, as a visual and/or aural warning.

Likewise, the moving map application 39 parses standard terminal arrival route (STAR) messages, compares the content of the STAR message with the actual flight data and provides an alert to the flight crew if there is a mismatch between the content of the STAR message and the actual flight data.

When the aircraft is being operated on the manoeuvring areas in preparation for take-off, the moving map display 69 provides an additional source of taxiway guidance using information taken from the PDC or from the ATIS, or from other air traffic clearances or instructions which specifies the runway in use and the taxi path to the take-off position. Information in the PDC which relates to the runway direction to be used for takeoff and the departure course to be flown, for example the use of a particular SID, is correlated by the moving map application 39 and shows the route from the park position to the takeoff position via the prescribed taxiways on the moving map display 69. If there are restrictions or closures that affect certain taxiways such as a NOTAM closing a taxiway, this information is displayed to the flight crew in a contrasting colour and using an obvious symbol to show the closure or restriction. Similarly, the moving map display 69 provides aural and visual warnings to the flight crew when a clearance limit has been specified as part of an air traffic clearance or instruction, and the clearance limit is approaching, the flight crew are alerted so as to prevent a runway incursion and a serious safety breach.

The electronic moving map application 39 automatically accepts data and information from authorised sources such as the ground-based component of the flight information system 10 or from other applications in the aircraft-based component 34 of the flight information system 10, or from other aircraft systems.

The moving map application 39 retrieves digital data from which the displays are presented to users. The use of digital data enhances safety as individual data objects are able to be updated, as opposed to the replacement of a raster type static chart display, thus the moving map application 39 enables maps and charts to be kept current and relevant to the flight being carried out. Furthermore, if required, the flight crew is able to use the look-ahead data feature to take a temporal view of the data and its presentation at a time in the future, for example for during a long haul flight. Temporality is incorporated into the data held on board the aircraft-based component 34 as synchronised and passed to it by the ground-based system so that in the event that a flight spans an AIRAC update cycle data, the static data on board the aircraft is current throughout the AIRAC update process period.

FIG. 6 shows in further detail the connection between various data and information sources such as Route Manuals, details of airspace configurations, airline manuals, topographic information, navigation data, weather data, NOTAM information, airline information, information contained in a flight crew briefing package such as the operational flight plan, NOTAM and weather for the flight, NOTAM and weather updates and information contained in an AIRAC cycle update. Data and information received by the aircraft-based component 34, such as NOTAM or weather, may be received in a coded message and using a meta-language which contain abbreviations and codes to indicate certain conditions or objects. When messages are received by the moving map application 39, codes or abbreviations contained in these messages are correlated with a database 141 via an analysis and parsing unit 140 that carries out analysis and parsing of the codes and abbreviations based on the decoding of the abbreviations and codes contained in the messages. The parsed information of the analysis and parsing unit 140 is made available to the moving map application 39 through an output 142 in the form of geo-referenced objects for placement on the moving map display 69 in the correct location. After placement of the NOTAM symbol, or placement of a weather symbol on the moving map display 69, users are able to select the symbol using the touchscreen user interface and by clicking on the symbol display the complete text message of the corresponding NOTAM, or weather information. Similarly, the data and information related to an object such as an aerodrome, or a navigation aid contained in a database in the aircraft-based component 34 is able to be displayed to users by selecting and clicking on the related symbol. For example if a user selects an aerodrome through the user interface, information relating to that aerodrome, such as the runway directions, runway lengths and widths, approach facilities, aerodrome facilities, as published by the State authority is displayed in a window on the moving map display 69.

Other NOTAM may be received in a digital format known as the aeronautical information exchange model or AIXM which has been developed and promulgated by Eurocontrol. The AIXM format is used to provide NOTAM in a digital format and contains data and information in a geographical markup language or GML which is able to be automatically geo-referenced and displayed on the moving map display 69. Similarly, weather information received in a digital format is displayed in the correct location by the moving map display 69. Weather information containing a location is automatically linked geographically to the aerodrome to which it refers, and for other types of weather such as a frontal system, or an area within which there is certain weather phenomena, for example turbulence or volcanic ash, or thunderstorms, the boundaries of the area as expressed either by locations, or by geographical coordinate values are automatically extracted from the weather message and displayed on the moving map display 69. Display of information in this manner provides the flight crew with a visual depiction of the NOTAM or of the weather conditions as they relate to the planned route of the flight, thus enhancing safety.

The analysis and parsing database contains listings of commonly used abbreviations and codes, together with the geographical references and coordinate values of locations. Location indicators published by the International Civil Aviation Organisation (ICAO) for airports consist of a series of four alphabetical characters, for example WSSS is the ICAO location code for Singapore, Changi airport. The Aeronautical Information Publication (AIP) published by Singapore as a contracting State to the Chicago Convention on Civil Aviation describes the details of Singapore, Changi airport including the latitude and longitude of the aerodrome reference point. The aircraft-based component 34 holds this information in its database and takes, for example, information relating to Singapore, Changi airport and displays it in the correct geographical reference points.

Data and information provided as part of the NOTAM and weather update is carried out in a dynamic way to ensure the flight crews are always in receipt of the latest, relevant data and information. The ground-based system receives data and information from a variety of sources and compares this data with the data which is known to be on board an aircraft. The ground-based system and the aircraft-based components 34 are synchronised with each other so that each other component knows which aircraft has what data and information.

The ground-based system, after receiving new data and information, or after receiving changed data and information correlates the new or changed data and information with the aircraft type, the route and timing of the flight, and other known aspects such as that derived from the operational flight plan, for example which alternate aerodromes the flight has nominated should the destination aerodrome become unsuitable, and after providing additional filtering to determine the relevance of the data and information, such as the height at which the aircraft will operate, the times at which the flight will take place, the airspace, airways and areas through which the flight will operate, and uplinks the changed data and information which has been filtered for relevance to the aircraft-based component 34. The moving map application 39 displays the new or changed data and information to the flight crew. Receipt of new or changed data and information is not, with the exception of those changes made in accordance with the AIRAC cycle, necessarily made at specific times, for example a NOTAM is issued when there is a notified outage of a facility or an outage is set for a pre-determined time. In the case of an outage which has not been predetermined, the NOTAM is issued shortly after the outage has been reported and is received by the ground-based system via the aeronautical fixed telecommunications network (AFTN) of the aeronautical telecommunications network (ATN). The ground-based system receives this information, filters for relevance for the aircraft-based component 34 and passes these changes to the aircraft-based component 34 for display and alerting of the flight crew.

When a SID is prescribed as part of the departure instructions or air traffic clearance in either a PDC or as part of the ATIS, or as part of other air traffic clearances or instructions, the moving map application 39 automatically displays the correct SID for the designated departure runway. If there are significant weather conditions likely to affect the departure procedures, these are displayed by the moving map application 39 to alert the flight crew to the conditions ahead. This is a particular safety enhancement during times when operations are being conducted in poor weather conditions such as low visibility operations. Similarly, when approaching an aerodrome, significant weather conditions on the missed approach path can be displayed to the flight crew to alert them if a missed approach is necessary.

Other symbols and warnings may be discontinued during the takeoff and landing phases of the flight so as not to provide a source of distraction to the flight crew. These symbols and warnings are configurable in the moving map application 39 on the aircraft-based component 34, for example by a user or according to a company guideline.

Information produced as part of the output from the flight planning system or other calculation tools or other applications in the aircraft-based component 34 are used in conjunction with the moving map application 39 and displayed to the flight crew. For example, when the onboard flight planning system generates an operational flight plan from the calculation tool or core system, the route of the flight together with a significant information likely to affect the progress of the flight is displayed on the moving map display 69. The flight crew are able to visually inspect the route of the flight and any constraints or restrictions or weather conditions to determine if the route is acceptable or another route needs to be specified in the flight planning system to avoid these constraints, restrictions or weather conditions.

FIG. 7 illustrates a display of graphical representations of aircraft related data and information by the moving map application 39. The data and information is displayed in different layers. The moving map application 39 allows a member of the flight crew to choose which of the layers to display. The layers may be toggled on and off during the flight or they may also be displayed according to pre-defined settings. The data which is displayed by the moving map application 39 comprises basic display information and additional display information. The basic display information is always shown and comprises the minimum information essential for the safe conduct of the flight. The information shown in the basic display is defined in accordance with a particular phase of flight and generally consists of that information which is most useful at that time, for example during an en-route phase of a flight, aerodromes that are unsuitable for the aircraft type being operated because of the length of the runway or the lack of facilities may not be shown on the moving map display 69. The aircraft-based component 34, after receiving a mission data set from the ground-based system, selectively filters data for relevance, taking the aircraft, and the performance of that aircraft into consideration when determining what is to be shown on the moving map display 69. The additional display information, on the other hand, is removable from the display or displayed on demand only and users are able to toggle information, such as the weather on or off from the display.

The display of information on the moving map display 69 is linked to the OOOI signals and presents information on the moving map display 69 in accordance with the particular phase of flight the aircraft is in, for example charts useful for movement of the aircraft on the manoeuvring area are presented to the flight crew when the OOOI signals that the aircraft is out of the parked area. Similarly, during the departure phase of the flight, the standard instrument departure (SID) for the airport is displayed, together with the procedures which the flight crew are to follow in the event of an engine out condition. The additional display information is considered not absolutely essential for the safe conduct of the flight.

The aircraft is plotted in a true motion mode which means that the update interval is small enough such that the position of the graphical representation of the aircraft on a map is always essentially coincides the true position of the aircraft on the map. The moving map application 39 uses information from GPS satellites and received by other aircraft systems connected to the cockpit display unit 90 and the moving map display 69 via an ARINC bus to retrieve the position of the aircraft. The moving map application 39 displays the flight route on which the aircraft is travelling.

After receiving NOTAM and weather data from the ground-based system via communications gateway and communications connections, the moving map application 39 displays selected NOTAM and weather data on a map. Part of the NOTAM and weather data is displayed automatically and part of it can be displayed on demand or according to user settings. The selection of information to be displayed by the moving map application 39 is made automatically by the aircraft-based component 34 to show information that is assessed as being more important to the flight crew, for example for a long haul flight, the destination weather information may not be displayed because this may change many times before the flight arrives there. The moving map application 39 displays the NOTAM and weather data by using a symbol or a text or other marking on the electronic moving map display 69. The symbols are stored in a memory and are conforming to an ICAO Annex or according to other standard setting organizations or are other symbols if a standardized symbol has not been published. Other symbols are used, in particular when no standard symbology has been established by a standard setting organization. By way of example, FIG. 5 shows a NOTAM message which is displayed next to a flight route and a symbol for a weather front border. NOTAM displayed by the moving map display 69 are able to be shown by a symbol which shows the effect of a NOTAM, for example an aerodrome which is closed, can be shown with an airport symbol over which a crossed diagonal line is drawn in a contrasting colour.

According to user settings, at least part of the updates to information previously received by the ground-based system are indicated by an aural or visual alert in order to draw attention to the flight crew. Furthermore, it is possible for the flight crew to make user defined entries. The moving map application 39 displays the user defined entries on the electronic moving map display 69 and these are displayed in proximity to the point that the information entered by the flight crew refers to.

The moving map application 39 displays pilot notes from pilots of other aircraft. Pilot notes is information that has been received by the aircraft based system as part of the data and information received from the airline office via the airline data supply. Moreover, the flight crew can also enter pilot notes by using an onscreen keyboard on the cockpit display unit 90 or a detachable keyboard unit 91. Part of the pilot notes relate to procedures that are suggested or recommended to be used in certain portions of a flight. For example, a pilot note may given by a company procedure which requests the pilots to make broadcasts to alert other aircrafts next to the plane if the plane approaches an airspace boundary.

The moving map application 39 further displays information which has been entered by the flight crew and which is in relation to the position of the aircraft on the flight route, for example an air report (AIREP). The flight crew can enter information via the touch screen in the pilot display device or through a detachable keyboard unit. The flight route related information comprises, for example, a waypoint or other position, the height the aircraft is operating at, an estimate for another position, weather information and the remaining fuel on board of the aircraft and combines this information with weather conditions observed or taken from other onboard sensors such as those for recording the spot wind and the outside temperature.

The moving map application 39 also shows information received from aircraft systems. For example, the information from aircraft systems comprises Out, Off, On, In (OOOI) data. The OOOI data is related to the movement of the aircraft. Furthermore, the aircraft based system receives digital aerodrome terminal information services (D-ATIS) or digital VOLMET information (D-VOLMET) via an ARINC 429 bus or an other aircraft data bus or aircraft connectivity system. The moving map application 39 processes part of the D-ATIS and D-VOLMET messages and displays information from those messages on the electronic moving map display 69.

The aerodrome terminal information service (ATIS) is usually provided in form of a broadcast and relates to information concerning an aerodrome and to local weather conditions, runways and taxiways to be used, radio frequencies in use and other information which is relevant to a flight crew. While the ATIS service is provided on a separate radio frequency, the D-ATIS service is provided in digital form and can be transmitted via one of the existing communication channels. Therefore, there is no need to tune in on separate radio frequency of an airport. Likewise, VOLMET is transmitted on a separate radio frequency whilst the D-VOLMET service does not require tuning in on a separate radio frequency. ATIS usually contains information relating to a local aerodrome and VOLMET usually contains warnings of significant weather conditions (SIGMET) and actual and forecast weather conditions for a number of aerodromes within a flight information region.

The moving map application 39 may also present weather messages from other aircraft based weather detection systems such as messages from a predictive/reactive windshear system (PWS/RWS) or from other aircraft systems and sensors used to detect the presence of volcanic ash. The weather detection systems generate messages in response to measurements from aircraft based instruments such as weather RADAR, weather LIDAR and infrared sensors.

The aircraft based system furthermore receives controller pilot data link communications (CPDLC) and other datalink messages from air traffic control such as Pre-departure clearances (PDC) from aircraft based systems or equipment via an ARINC 429 bus or other aircraft data bus or connectivity application. The moving map application 39 processes and displays part of the CPDLC and PDC messages and displays data from the CPDLC or PDC messages on the electronic moving map display 69. In particular, the CPDLC and PDC messages comprise messages from air traffic services provides. As described above, when a CPDLC or PDC message is received by other aircraft based systems and passed to the moving map application 39 of the aircraft-based component 34, and parts of these messages are displayed to the flight crew, and these parts of these messages contain an air traffic clearance or air traffic instruction, the moving map application 39 correlates the information in the air traffic clearance of air traffic instruction with the route of the flight and monitors and provides a warning to the flight crew if they are not adhering to the terms of an air traffic clearance or an air traffic instruction.

The moving map application 39 on the aircraft-based component 34 also provides warnings to the flight crew if the terms of the air traffic clearance or air traffic instruction are likely to bring them into conflict or into the vicinity of another aircraft of high terrain, and if a taxi clearance or instruction is likely to cause a runway incursion.

Moreover, the aircraft based system receives automatic dependent surveillance (ADS) broadcasts, ADS traffic information broadcasts (TIS-B) and/or flight information service broadcasts (FIS-B) from aircraft based systems or equipment via an ARINC 429 bus or other aircraft data bus or connectivity application. The moving map application 39 processes part of the ADS, TIS-B and FIS-B information and displays it on the electronic moving map display 69. The TIS-B broadcasts comprise information relating to other aircraft in the vicinity. The FIS-B broadcasts provide weather text, weather graphics, NOTAMS, ATIS and similar information. The moving map application 39 furthermore displays surveillance information, for example ADS-B information, that relates to the presence of other aircraft. The position of the other aircraft is displayed on the electronic moving map display 69.

Similarly, the aircraft based system receives information from a traffic alert and collision avoidance system (TCAS) from aircraft based systems or equipment via an ARINC 429 bus data bus or an other aircraft data bus or communications system. The moving map application 39 processes part of the TCAS messages and displays information from the TCAS messages on the electronic moving map display 69.

Furthermore, the aircraft based system also receives information form a terrain awareness warning system (TAWS), from a ground proximity warning system (GPWS) and/or from an enhanced ground proximity warning system from aircraft based systems or equipment via an ARINC 429 bus or an other aircraft bus or connectivity system. The moving map application 39 processes part or all of the GPWS and TAWS messages and displays information from the GPWS and TAWS messages on the electronic moving map display 69. The moving map application 39 may display a proximity warning even when a danger of ground collision is not immediately imminent to give the pilots more time to take appropriate decisions. This is especially advantageous in connection with GPS based systems like EGPWS which provide a wider range of forecast than purely instrument based systems.

FIG. 7 shows an electronic moving map display 69 on which data and information is displayed by the moving map application 39. The moving map 68, which is displayed on the electronic moving map display 69, comprises a topographical background, a flight route 71, a position symbol 72 of the aircraft and position symbols 111 of other aircrafts in the vicinity and of further information, such as information from the above-mentioned data sources.

The moving map application 39 generates the background of the moving map display 69 according to topographical data which is stored in an onboard memory as part of the onboard static data load 35. In particular, the background comprises topographic symbols 79. By way of example, FIG. 6 shows a topographic symbol 79 for a water surface, a topographic symbol 79 for a mountain and a symbol 70 for a navigation aid which is next to a flight route. The moving map application 39 also displays further symbols on the moving map 68 such as symbols for an airspace configuration and for obstructions. For example, an airspace boundary is shown as boundary line 78 and may include the class of airspace where the boundary division takes place or may refer to a flight information region boundary and the change of responsibility for the airspace within which the flight will operate. Similarly, radio frequencies may be shown on the moving map display 69 to indicate a particular radio frequency or frequencies the flight crew should use to contact air traffic services providers responsible for the provision of certain services in the airspace. If the radio frequencies are changed, or become unavailable, this information is part of the dynamic data update provided to the flight crew and is displayed on the moving map display 69. Similarly, if the air traffic services in an airspace are changed, or are not available, and, for example pilots are required to use a radio broadcast system such as TIBA (traffic information broadcasts by aircraft) and is used to alert other traffic in the airspace, this type of information is shown on the moving map display 69, as is the area within which the broadcasts are required to be made, together with the radio frequencies the broadcasts are made on, and any parameter time before reaching the boundary of the airspace that the radio broadcasts are required to be made.

The moving map application 39 also displays information contained in Route manuals which apply to certain portions of the airspace and information provided by the airline such as company standard operating procedures.

FIG. 7 further shows a route of flight 71. The moving map application 39 retrieves the flight route 71 from the static data load 35 or also from an output data of a flight planning system and displays it on the moving map 68. The flight route shows waypoint symbols 73. The waypoint symbols 73 correspond to waypoints along the flight route 71, which are, for example, locations where the flight crew is required to make reports to air traffic services. The location of a waypoint is defined by longitude and latitude coordinates.

The flight crew can make reports to the air traffic services, also referred to as “en-route reports”, by using the onboard communications channels. The en-route reports can be entered into the aircraft based system by the detachable keyboard 91 or via an on onscreen keyboard device on the touch screen. The moving map application 39 may furthermore display information about the fuel status as part of the en-route report. In FIG. 6, an en-route position report 110 is displayed on the electronic moving map display 69 next to the corresponding waypoint. Pilot notes 74 can be attached to the graphical symbols of the moving map 68. The pilot notes provide additional information to the flight crew, such as a request to make additional broadcasts in the vicinity of an airspace boundary so as to alert other flight crews to their presence. In FIG. 7 this is shown as a pilot note 74 which is attached to an airspace boundary symbol 78 by a solid line.

As described above, the flight crew receives controller pilot data link messages from air traffic services providers as well as VOLMET and ATIS information. In FIG. 7, these information is shown as corresponding textboxes 113, 114. A D-ATIS message 113 is shown by a text box which is attached to the airport symbol that it refers to by a line.

Furthermore, the moving map application 39 retrieves a current aircraft position and displays it on the moving map 68 by an appropriate symbol. For data which is displayed on the moving map 68 and is associated with a geographic location the moving map application 39 may display the geographical coordinates of the data. In memory, the objects are stored, for example, by using a geographic information system (GIS), a geographic markup language (GML) or any other suitable mapping language, such as the keyhole markup language (KML).

FIG. 8 shows a section of a flight route. In contrast to FIG. 7 which shows a short range or “tactical” display of a flight route 71, FIG. 8 shows a long range or “strategic” display of a flight route 71 which includes the complete flight route 71 including a start point and an end point of the flight route 71. The long range display may cover half the earth's surface, as shown in FIG. 8, or part of the earth's surface or even the complete surface of the earth. The moving map application 39 represents the flight route as a polygon wherein the edges of the polygons are given by waypoints. In FIG. 8 the waypoints are not associated with a request for reports, as in FIG. 5, and are not shown as triangular symbols.

The subject of the application comprises furthermore the below mentioned devices and methods. The devices are provided by soft- and hardware onboard the aircraft, as shown for example in FIG. 5, such as the display unit 90, the communications connections 32, 37, the communication and connectivity bus, onboard applications 36 and various onboard data sources which may be provided by data in onboard memory, by received communication signals, by instrument readings or otherwise. Some of these onboard data sources are shown in FIG. 5 as rectangles which are connected to the cockpit display unit 90 and to the onboard applications 36.

In one aspect, the application discloses a device for automatically evaluating an air traffic control message by an aircraft-based component of a flight information system. An air traffic control message in this sense comprises all kinds of aeronautic messages from an official source, not only ATC messages but also NOTAM, TAF and other weather messages. Moreover, the air traffic control message may be provided by a D-ATIS message, a D-VOLMET message or a CPLDC message. 6.

According to one aspect, the air traffic control message is a pre departure clearance message which comprises a standard instrument departure. The air traffic control message may furthermore be received from an automated terminal information service. An automatic inclusion of information from the pre departure clearance message into the moving map display according to the application enhances flight security, a separate paper sheet which could distract the crew is now longer needed.

The device comprises means for retrieving the air traffic control message from an aircraft-based system, such as the aircraft communications bus 116 shown in FIG. 4. Furthermore, the device comprises means for parsing the text of the air traffic control message and means for storing text elements of the air traffic control message into a computer readable memory. These means may be provided by a computer program which is stored in the computer readable memory. The computer readable memory is provided on board the aircraft, for example in the cockpit display unit 90 or in a separate computer rack on board the aircraft.

Furthermore, the device comprises means for retrieving a current flight data of an aircraft, such as data from the onboard static data load 35 which apply to the current position and time, data from aeronautic messages or other onboard systems. The actual flight data comprises at least the current position of the aircraft. Moreover, the device comprises means for determining if there is a mismatch between the stored text elements and the current flight data and means for displaying one or more graphical elements on a moving map display 120 if it is determined that there is a mismatch between the stored text elements and the current flight data.

Similarly, the application discloses a method for automatically evaluating an air traffic control message by an aircraft-based component of a flight information system. The air traffic control message is retrieved from an aircraft-based system, the text of the air traffic control message is parsed and text elements of the air traffic control message are stored into a computer readable memory.

A current flight data of an aircraft is retrieved and it is determined if there is a mismatch between the stored text elements and the current flight data, wherein the actual flight data comprise at least the current position of the aircraft. The mismatch may be given, for example, by a minimum difference between the center of the displayed moving map and the current position of the aircraft that is exceeded but also by a display condition which is fulfilled for a graphical item that is not currently displayed or which is no longer fulfilled for a graphical item that is currently displayed. If it is determined that there is a mismatch between the stored text elements and the current flight data, one or more graphical elements are displayed on a moving map display.

The method may furthermore comprise the following steps: A prescribed position of the aircraft is derived from the stored text elements in the computer readable memory. The current position of the aircraft is correlated with the prescribed position of the aircraft. A mismatch flag is output if the deviation between a prescribed position of the aircraft and the actual position of the aircraft is greater than a predetermined value.

Moreover, the method may comprise comparing the current daytime with a clearance limit and outputting a mismatch flag if the difference between the clearance limit and the current daytime falls below a predetermined value.

Similarly, the application discloses a method for automatically evaluating an air traffic control message by an aircraft-based component of a flight information system. The air traffic control message is retrieved from an aircraft-based system and the text of the air traffic control message is parsed. Text elements of the air traffic control message are stored into a computer readable memory and a current flight data of an aircraft is retrieved. It is determined if there is a mismatch between the stored text elements and the current flight data. The actual flight data comprises at least the current position of the aircraft. One or more graphical elements are displayed on a moving map display if it is determined that there is a mismatch between the stored text elements and the current flight data.

In a further aspect, the application discloses a device for retrieving geographically correlated pilot notes in a moving map display. The pilot notes may be geographically correlated by an attachment to a geographically coordinated item. This is shown in FIG. 7, where a pilot not 74 is attached to an airspace boundary 78. The device comprises means for deriving a geographical position from a first input device. The first input device may be provided by the GPS system 121, shown in FIG. 5 or by a computed aircraft position, which is computed by an onboard application 36. Furthermore the device comprises means for deriving a geographical position and for displaying a graphical symbol at a geographical position. Means for reading in a pilot note text from a second input device are provided. For example, the pilot note text may be read in by a keyboard 91. The graphical symbol at the geographical position may display the text as it is entered. For example, it may be provided by a text entry box which is attached to another graphical symbol, as shown in FIG. 7. The device comprises means for storing the pilot note text as a pilot note text item in a database as a geographically correlated information. The pilot note text may be stored in an aircraft based database which is provided in a memory of the cockpit display unit 90 or in another aircraft based memory.

Similarly, the application discloses a method for retrieving geographically correlated pilot notes. A geographical position is derived from a first input device and it is displayed by a graphical symbol on a moving map display. A pilot note text is read in from a second input device. The pilot note text is stored as a pilot note text item in a database as a geographically correlated information, for example by providing a link to another geographically correlated item or by providing geographical coordinates.

According to the application, a pilot report can be generated from pilot notes which have been generated according to the abovementioned method or which are retrieved from the static data load in accordance with the following method. Geographically correlated pilot note text items from are retrieved from an aircraft-based database and a pilot report message is generated from the pilot note text items. The pilot report message is transmitted via a transmitter of an aircraft. It can then be received by a ground based system and distributed to other aircraft, for example.

In a further aspect, the application discloses a device for displaying a look ahead information in a moving map display. The device comprises means for retrieving a look ahead time from an input device. The look ahead time may be provided by a user input or by program which simulates the flight of the aircraft.

Extrapolation means are provided for deriving a future aircraft position at the look ahead time and means for determining a segment of a map to be displayed, such as the flight route shown in FIG. 7. Furthermore, the device comprises means for retrieving geographically correlated information items for a map segment to be displayed. These items may be retrieved from the onboard static data load 35, for example. The device according to the application comprises display means for displaying the map segment and displaying the geographically correlated information items and for displaying the aircraft position at the look ahead time. These display means may be provided by an onboard application 36 and further hardware such as a display controller and a portion of the display of the cockpit display unit 90.

Similarly, the application discloses a method for displaying look ahead information in a moving map display. A look ahead time is retrieved from an input device. This may be done from a user input via keyboard or from a simulation program, in which case the input device is part of a computer program. A future aircraft position is derived at the look ahead time and a segment of a map to be displayed is determined. Geographically correlated information items are retrieved which relate to a map segment to be displayed. The map segment, the geographically correlated information items, and an aircraft position at the look ahead time are displayed on the moving map display.

Furthermore, the display of the look ahead information may comprise comparing a validity time range of at least one geographically correlated information item with the look ahead time and determining if the look ahead time lies within the validity time of the geographically correlated information item. This can be applied, for example, to a terminal area forecast which is associated to a geographical location and has a validity time. If it is determined that the look ahead time lies within the validity time range of the geographically correlated information a graphical symbol of the geographically correlated information item is displayed.

In a further aspect, the display of the look ahead information may also comprise retrieving a geographically correlated message, parsing the geographically correlated message and generating a geographically correlated information item by attributing a geographical location of the geographically correlated message to a text portion of the geographically correlated message. For example, an ASHTAM message may refer to a specific location of a volcano. The message may be expandable on user action, for example by clicking, to provide an uncluttered display. Alternatively or in addition, graphical symbols for messages of certain types may be toggled on and off by user action.

In a further aspect, the application discloses a device for selectively displaying information in a moving map display of an aircraft. The device comprises means for determining a flight phase of the aircraft, means for determining, depending on the flight phase, a set of essential data to be displayed and display means for displaying the set of essential data on the moving map display. By only displaying data that is relevant to a specific flight phase, such as take-off, cruise and landing, the display on the moving map display becomes less cluttered and the security is enhanced. The flight phase may be deduced from instrument data, from flight computer data or even from user input.

Similarly, the application discloses a method for selectively displaying information in a moving map display of an aircraft. A flight phase of the aircraft is determined and, depending on the flight phase, a set of essential data to be displayed is determined. The set of essential data is displayed on the moving map display.

The step of determining a flight phase may comprise, for example, retrieving a signal from an OOOI system, which is shown in FIG. 5 as OOOI system 122. The information that is to be displayed during a specific flight phase may furthermore be configurable. In this case, the step of determining the set of essential data comprises retrieving predefined settings, wherein the predefined settings comprise a definition of information to be displayed during a predetermined flight phase. The predefined settings are stored in an onboard memory of the aircraft.

In a further aspect, the selective display of information may refer to a facility with certain capabilites. For example, an airport may not be suitable for landing of an Airbus A-380. According to this aspect the selective display comprises comparing the capabilities of a facility with the technical data of the aircraft. It is determined if the capabilities of the facility match with the technical data of the aircraft. If it is determined that the capabilities of the facility do not match with the technical data of the aircraft, the facility is added to a list of information items not to be displayed.

The step of determining the set of essential data to be displayed may further comprise selecting a layer of information to be displayed, for example all major roads or all mountains above a predetermined height.

In a further aspect, the application discloses a method for displaying flight related data in a moving map display of an aircraft. A flight related information is retrieved from a database at a service provider's data centre, for example the data centre 14 of FIG. 1.

The flight related information to is sent to the aircraft via a global satellite network and the flight related information is parsed into information items. In other words, information items are identified within the flight related information which are to be associated with a graphical symbol. Graphical symbols and geographical positions are assigned to the information items. The graphical symbols are displayed on a moving map display next to the assigned geographical positions. By way of example, FIG. 7 shows graphical symbols 70, 71, 72, 73, 76, 79, 111, 110, 112, 113, 114.

In a further aspect, the application discloses a device for displaying a collision hazard in a moving map display, the device comprising means for retrieving information from a collision warn system via an aircraft data bus, such as aircraft communications and connectivity bus of FIG. 4 which is connected to a TAWS system. The device comprises display means for displaying a warning in a moving map of a moving map display, based on an evaluation of the retrieved information.

Similarly, the application discloses a method for displaying a collision hazard in a moving map display. Information from a collision warn system is retrieved via an aircraft data bus and a warning is displayed in a moving map of a moving map display.

The provision of a graphical depiction according to the application in either a selectable 2-D or 3-D mode of the route to be operated on enhances the flight security by improving the situational awareness of the flight crew. The inclusion into the moving map display 69 of automatically directed updates to the onboard data set, NOTAM, weather, and operational information according to the application provides a concise way of linking different types of information which the flight would otherwise have to be combined from different sources. According to the application, the moving map display 69 is linked to other aircraft systems to provide graphical warnings to the flight crew, for example when the route of the flight is likely to bring the aircraft in close proximity with high terrain or to other aircraft in the vicinity. A pilot of the aircraft does not have to look at a separate device to receive the warning but the collision warning is already included in the moving map display 69 and is thus shown in the context of the other information of the moving map display 69.

Through the automatic analysis of ATC and other messages according to the application, such as pre departure clearances, the automatic correlation with the aircraft's position and the automatic display of imminent or already occurred mismatches with the ATC messages on the moving map display possible sources of errors are avoided as compared to the manual handling of documents and voice messages.

Although the above description contains much specificity, these should not be construed as limiting the scope of the embodiments but merely providing illustration of the foreseeable embodiments. Especially the above stated advantages of the embodiments should not be construed as limiting the scope of the embodiments but merely to explain possible achievements if the described embodiments are put into practise. Thus, the scope of the embodiments should be determined by the claims and their equivalents, rather than by the examples given.

### REFERENCE NUMBERS

9 service provider's operations support center
10 flight information system
11 aircraft
13 satellite
14 service provider's data center
15 satellite communication link
16 airport communication links
17 airports
18 first secure internet connection
19 airline communication links
20 airline offices
22 Bluetooth data link
23 antenna
31 operations center
32 communications gateway system
33 airline information providers
34 aircraft-based component
35 onboard static data load
36 onboard applications
37 communication means
39 moving map application
40 nav interface
41 NOTAM interface
42 weather interface
43 airline interface
44 interface
45 briefing packages
46 load sheets
47 weather updates
48 update channel
49 distribution channel
51 flight planning unit/system
53 secure channel
54 main database
56 airline data source
58 user interface
59 output interface
60 flight planning engine
61 route optimizer
68 moving map
69 moving map display
70 navigation aid symbol
71 flight route
72 symbol for own aircraft
73 waypoint symbol
74 pilot note display
75 NOTAM display
76 weather symbol
78 airspace boundary symbol
79 topographic symbol
90 cockpit display unit
91 detachable keyboard unit
111 symbol for other aircraft
112 CPDLC and ATS message data source
113 D-ATIS message data source
114 D-VOLMET message data source
115 aircraft based systems
116 communications and connectivity bus
121 GPS system
122 OOOI events data source
123 Fuel system and monitoring data source
140 analysis and parsing unit
141 database
142 output

1. Device for automatically evaluating an air traffic control message by an aircraft-based component of a flight information system, the device comprising
means for retrieving the air traffic control message from an aircraft-based system;
means for parsing the text of the air traffic control message;
means for storing text elements of the air traffic control message into a computer readable memory;
means for retrieving a current flight data of an aircraft;
means for determining if there is a mismatch between the stored text elements and the current flight data, the actual flight data comprising at least the current position of the aircraft;
means for displaying one or more graphical elements on a moving map display if it is determined that there is a mismatch between the stored text elements and the current flight data.

2. Method for automatically evaluating an air traffic control message by an aircraft-based component of a flight information system, the method comprising the steps of
retrieving the air traffic control message from an aircraft-based system;
parsing the text of the air traffic control message;
storing text elements of the air traffic control message into a computer readable memory;
retrieving a current flight data of an aircraft;
determining if there is a mismatch between the stored text elements and the current flight data, the actual flight data comprising at least the current position of the aircraft;
displaying one or more graphical elements on a moving map display if it is determined that there is a mismatch between the stored text elements and the current flight data.

3. Method according to claim 2, the step of determining the mismatch further comprising
deriving a prescribed position of the aircraft from the stored text elements in the computer readable memory;
correlating the current position of the aircraft with the prescribed position of the aircraft;
outputting a mismatch flag if the deviation between a prescribed position of the aircraft and the actual position of the aircraft is greater than a predetermined value.

4. Method according to one of claim 2 or 3, the step of determining the mismatch further comprising
comparing the current daytime with a clearance limit;
outputting a mismatch flag if the difference between the clearance limit and the current daytime falls below a predetermined value.

5. Method according to one of claims 2 to 4, wherein the air traffic control message is a D-ATIS message/D-VOLMET message/CPLDC message.

6. Method according to one of claims 2 to 5, wherein the air traffic control message is a pre departure clearance message.

7. Method according to claim 6, wherein the pre departure clearance comprises a standard instrument departure.

8. Method according to one of claims 2 to 7, wherein the air traffic control message is received from an automated terminal information service.

9. Device for retrieving geographically correlated pilot notes in a moving map display, the device comprising
means for deriving a geographical position from a first input device and for displaying a graphical symbol on a moving map display at the geographic position;
means for reading in a pilot note text from a second input device;
means for storing the pilot note text as a pilot note text item in a database as a geographically correlated information.

10. Method for retrieving geographically correlated pilot notes, the method comprising
deriving a geographical position from a first input device, the geographical position being displayed by a graphical symbol on a moving map display;
reading in a pilot note text from a second input device;
storing the pilot note text as a pilot note text item in a database as a geographically correlated information.

11. Method for automatically generating a pilot report, the method comprising
retrieving geographically correlated pilot note text items from an aircraft-based database,
generating a pilot report message from the pilot note text items;
transmitting the pilot report message via a transmitter of an aircraft.

12. Device for displaying a look ahead information in a moving map display, the device comprising
means for retrieving a look ahead time from an input device;
extrapolation means for deriving a future aircraft position at the look ahead time;
means for determining a segment of a map to be displayed;
means for retrieving geographically correlated information items for a map segment to be displayed;
means for displaying the map segment and displaying the geographically correlated information items;
display means for displaying the aircraft position at the look ahead time.

13. Method for displaying a look ahead information in a moving map display, comprising the steps of
retrieving a look ahead time from an input device;
deriving a future aircraft position at the look ahead time;
determining a segment of a map to be displayed;
retrieving geographically correlated information items for a map segment to be displayed;
displaying the map segment and displaying the geographically correlated information items;
displaying the aircraft position at the look ahead time.

14. Method according to claim 13, wherein the step of retrieving comprises
comparing a validity time range of at least one geographically correlated information item with the look ahead time;
determining if the look ahead time lies within the validity time of the geographically correlated information item;
displaying a graphical symbol of the geographically correlated information item if it is determined that the look ahead time lies within the validity time range of the geographically correlated information.

15. Method according to claim 13 or 14, further comprising
retrieving a geographically correlated message;
parsing the geographically correlated message;
generating a geographically correlated information item by attributing a geographical location of the geographically correlated message to a text portion of the geographically correlated message.

16. Device for selectively displaying information in a moving map display of an aircraft, the device comprising
means for determining a flight phase of the aircraft;
means for determining, depending on the flight phase, a set of essential data to be displayed;
display means for displaying the set of essential data on the moving map display.

17. Method for selectively displaying information in a moving map display of an aircraft comprising the steps of
determining a flight phase of the aircraft;
depending on the flight phase, determining a set of essential data to be displayed;
displaying the set of essential data on the moving map display.

18. Method according to the claim 17, wherein the step of determining the flight phase comprises retrieving a signal from an OOOI system.

19. Method according to one of claims 17 to 18, wherein the step of determining the set of essential data comprises retrieving predefined settings, the predefined settings comprising a definition of information to be displayed during a predetermined flight phase.

20. Method according to one of the claims 17 to 19, further comprising
comparing the capabilities of a facility with the technical data of the aircraft;
determining if the capabilities of the facility match with the technical data of the aircraft;
if it is determined that the capabilities of the facility do not match with the technical data of the aircraft
adding the facility to a list of information items not to be displayed.

21. Method according to one of the claims 17 to 20, wherein the step of determining the set of essential data to be displayed further comprises selecting a layer of information to be displayed.

22. Method for displaying flight related data in a moving map display of an aircraft comprising the steps of
retrieving flight related information from a database at a service provider's data center;
sending the flight related information to the aircraft via a global satellite network;
parsing the flight related information into information items;
assigning graphical symbols to the information items;
assigning geographical positions to the information items;
displaying the graphical symbols on a moving map display next to the assigned geographical positions.

23. Device for displaying a collision hazard in a moving map display, the device comprising
means for retrieving information from a collision warn system via an aircraft data bus;
display means displaying a warning in a moving map of a moving map display.

24. Method for displaying a collision hazard in a moving map display, comprising the steps of
retrieving information from a collision warn system via an aircraft data bus;
displaying a warning in a moving map of a moving map display.
